(19) United States
(12) Patent Application Publication
(10) Pub. No.: US 2016/0068292 A1
(43) Pub. Date: Mar. 10, 2016

(54) Tool-integrated valve for rough and/or fine vacuum

(71) Applicant: GEA FOOD SOLUTIONS GERMANY GMBH, Biedenkopf-Wallau (DE)

(72) Inventor: Alexander FRIES, Biedenkopf-Wallau (DE)

(21) Appl. No.: 14/785,979

(22) PCT Filed: Apr. 17, 2014
(86) PCT No.: PCT/EP2014/057876

§ 371 Date: Oct. 21, 2015

(30) Foreign Application Priority Data
Apr. 24, 2013 (DE) 10 2013 207 418.2

(51) Int. Cl. B65B 51/10; B65B 31/00; B65B 47/04; F16K 24/00

(52) U.S. Cl. CPC B65B 51/10; F16K 24/00; B65B 31/00; B65B 47/04

(57) ABSTRACT

The present invention relates to a packaging machine (1) having:—a filling station (7), in which packaging depressions (6) are filled with a material to be packaged (16),—a sealing station (15) at least having an upper tool (12) and a lower tool (11) which seal an upper film web (14) to the packaging depression (6), wherein the sealing station (15) has at least one valve which connects the lower tool (11) and/or upper tool (12) reversibly to a rough and/or fine vacuum source. Furthermore, the present invention relates to a sealing tool.

The present invention relates to a packaging machine having:
a filling station, in which packaging depressions are filled with a material to be packaged,
a sealing station at least having an upper and a lower tool which seal an upper film web to the packaging depression, wherein the sealing station has at least one valve which connects the lower and/or upper tool reversibly to a rough and/or fine vacuum source.

Furthermore, the present invention relates to a sealing tool.

Packaging machines and sealing tools of this type are known from the prior art and are used, for example, in order to pack sliced foodstuffs, for example slices of sausage, cheese and/or ham or other products that can be weighed and/or counted. These packaging machines are designated as forming-filling-sealing packaging machines (FFS packaging machines), for example thermoformers, or filling-sealing packaging machines (FS packaging machines), for example traysealers. In the first, a lower film web is transported cyclically along the packaging machine and firstly one or more packaging depression(s) per format are molded into the previously heated lower film web by using a plunger or negative pressure. Each packaging depression is then filled in a filling station with slices of material to be packaged, in particular foodstuff slices, or other materials to be packaged, subsequently closed with an upper film and then separated. In the case of an FS packaging machine, the molding method step is omitted. The packaging depressions are made available as finished “trays”, are filled and then closed. Often, the packages have an atmosphere that differs from air. For this purpose, preferably a vacuum is first produced in the packaging depression and then filled again with a gas or gas mixture, for example carbon dioxide, nitrogen and/or oxygen. In particular the action of drawing the vacuum, what is known as evacuation, frequently lasts for a very long time arid is a limiting step for the overall performance of the packaging machine.

The object of the present invention was, therefore, to provide a packaging machine which does not have the disadvantages of the prior art.

The object is achieved by a packaging machine having:
a filling station, in which packaging depressions are filled with a material to be packaged,
a sealing station at least having an upper tool with an upper chamber and a lower tool with a lower chamber which seal an upper film web to the packaging depression, wherein the sealing station has at least one valve which connects the lower and/or upper tool reversibly to a rough and/or fine vacuum source,
   wherein the valve is arranged on the upper and/or lower tool and/or on the upper and/or lower chamber and/or a product chamber.

The disclosure made in relation to this subject of the present invention applies to the same extent to the other subjects of the present invention and vice versa.

The present invention relates to a packaging machine, in particular a forming-filling-sealing packaging machine (FFS packaging machine) or a filling-sealing packaging machine (FS packaging machine). In the first, a film web/lower film web is transported cyclically along the packaging machine and firstly heated. Then, one or more packaging depression(s) are molded into the lower film web into the heated lower film web, wherein one or more packaging depressions are arranged in what is known as a format, which is produced during one cycle. This molding of the packaging depressions into the film web can be effected by a plunger or assisted by a plunger and/or by negative pressure in a female die and/or by positive pressure into a female die. In the case of an FS packaging machine, for example a traysealer, the molding step is omitted. The packaging depression is made available as a finished “tray”.

This packaging depression is then filled in a filling station with slices of material to be packaged, in particular foodstuff slices, or other materials to be packaged that can be weighed and/or counted. After that, in a sealing station, an upper film is sealed onto the filled packaging depression. The upper film can also be deep-drawn. The finished packages are then separated by using a transverse cutter and/or longitudinal cutter or with a contour cut.

According to the invention, the sealing station at least has an upper and a lower tool which seal an upper film web to the packaging depression. The upper tool contains an upper chamber, the lower tool contains a lower chamber, and the space between packaging depression and upper film web forms the product chamber. The product chamber can be part of the lower and/or upper tool. Also according to the invention, the sealing station has at least one valve which connects the lower and/or upper tool reversibly to a rough and/or fine vacuum source, wherein the valve is arranged on the upper and/or on the lower tool. Each chamber is preferably connected to at least one valve.

In particular, at least one valve is preferably arranged on each chamber.

A vacuum source in the sense of the invention provides a vacuum for evacuating the packaging depressions. This can be, for example, a vacuum volume and/or a vacuum pump. Rough vacuum in the sense of the invention is a comparatively higher absolute pressure than fine vacuum. For example, rough vacuum is a pressure range ≧50 mbar, preferably 50-70 mbar. Fine vacuum is, for example, a pressure range <50 mbar, preferably 5-10 mbar.

In the sense of the invention, arranged on the upper and/or lower tool or arranged on the upper, product or lower chamber means that, no piece of conduit or, if at all, only a very short piece of conduit is provided between the valve and the upper and/or lower tool. Such a piece of conduit is, for example, a pipe-like or tube-like conduit but also, for example, a recess, in particular a bore, present in the workpiece and/or in the valve. Preferably, during a tool change, the valve is installed in or removed from the packaging machine together with the upper and/or lower tool. In the case of the upper and lower chamber, the conduit volume between the valve and the respective chamber is preferably less than 100 ml per valve, preferably less than 50 ml, particularly preferably less than 30 ml and still more preferably less than 20 ml. In the case of the product chamber, the volume of the conduit is preferably less than 2, preferably less than 1.5 and particularly preferably less than 1 and quite particularly preferably less than 0.75, in each case measured in ml of conduit volume per mm of feed and per valve, wherein the feed is the length of the feed of the lower film web during one cycle.

As a result of the extremely short distance between the valve and the upper and/or lower tool or upper, product or lower chamber, the volume of the feed line, which must be large in order to increase the flow velocity, is reduced. In addition to the advantage of the volume reduction, a further advantage is the optimization of the conductance in the discharge path of the air. This is because, as far as the upper and/or lower tool, the vacuum tubes can be laid either straight or with large radii. Furthermore, it is then necessary for flow to pass through only one valve instead of two. A vacuum distributor which may possibly be present, which permits the distribution from one conduit to a plurality of valves, is optimized in terms of flow.

Usually, between the upper and the lower tool or between the upper and lower chamber, a product chamber, which is likewise evacuated during a gas exchange, is also provided. This product chamber is preferably assigned at least one valve, wherein the explanations relating to the valve referring to the upper and the lower tool apply to the same extent to the valve of the product chamber.

Preferably, the same negative pressure is produced in the upper chamber, in the lower chamber and/or in the product chamber.

A further preferred or inventive subject of the present invention is a packaging machine in which the valve has a valve seat and a movable element which interacts in a sealing manner with the valve seat, and in which the valve seat is part of the lower or upper tool.

The disclosure made in relation to this subject of the present invention applies to the same extent to the other subjects of the present invention and vice versa.

This preferred or inventive embodiment of the present invention has the advantage chat there is a minimal or even no distance between the valve and the upper, lower tool or the upper, product and/or lower chamber. The valve is part of the tool chamber or the product chamber and, in the event of a tool change, is replaced together with the same. The valve is matched optimally to the respective tool. The upper and the lower tool or the upper, product and/or lower chamber preferably each have a valve for rough and fine vacuum. After a new tool has been installed in the packaging machine according to the invention, the valves merely have to be connected to the respective vacuum source. The conduit between the valve and the vacuum source does not need its volume to be optimized in any way, instead it can be optimized exclusively with regard to flow resistance.

Preferably, the valve seat is provided in one piece with the lower and/or upper tool or the upper, product and/or lower chamber. The valve seat is then, for example, machined in a material-removing manner into the respective tool or the product chamber.

For the case in which valves for rough and fine vacuum are provided, the latter can be implemented differently. For example, the valve for the rough vacuum can be provided merely as a flap without drive.

A further preferred or inventive subject of the present invention is a packaging machine in which in the region of the lower and/or upper tool or the upper, product and/or lower chamber, in each case two valves are provided wherein one valve has only fine vacuum applied thereto and the other valve has only rough vacuum applied thereto.

The disclosure made in relation to this subject of the present invention applies to the same extent to the other subjects of the present invention and vice versa.

According to the invention, each tool and/or each chamber has two valves, wherein one valve has only fine vacuum applied thereto and the other valve has only rough vacuum applied thereto. As a result, once more the volumes which have to be evacuated when changing over from rough to fine vacuum beside the respective tool or the respective chamber can be reduced, which means that the time which is needed for the evacuation can be reduced and comparatively low suction power, that is to say low pump power, is needed to maintain the vacuum. In the sense of the invention, “in the range” means that the conduit volume in the upper and lower chamber between the valve and the respective chamber is preferably less than 100 ml per valve, preferably less than 50 ml, particularly preferably less than 30 ml and still more preferably less than 20 ml. In the case of the product chamber, the volume of the conduit is preferably less than 2, preferably less than 1.5 and particularly preferably less than 1 and quite particularly preferably less than 0.75, in each case measured in ml of conduit volume per mm of feed and per valve, wherein the feed is the length of the feed of the lower film web during one cycle.

A further subject of the present invention is a sealing tool of a packaging machine, characterized in that it has at least one, preferably two, valves.

The disclosure made in relation to this subject of the present invention applies to the same extent to the other subjects of the present invention and vice versa.

According to the invention, each tool and/or each chamber has a valve, which is in particular firmly connected to the respective tool. In the event of a tool change, the respective valve is consequently replaced jointly with the tool or the product chamber.

Preferably, each valve has a valve seat and a movable element, for example a plunger, which interacts in a sealing manner with the valve seat, wherein the valve seat is part of the lower or upper tool or the upper, product or lower chamber. Preferably, the valve seat is provided in one piece with the lower and/or upper tool.

A further subject of the present, invention is a method for evacuating a chamber of a sealing tool, in which firstly a rough vacuum is applied to a first valve set, which comprises at least two valves, and then a fine vacuum is applied to another valve set, which comprises at least two valves.

The disclosure made in relation to this subject of the present invention applies to the same extent to the other subjects of the present invention and vice versa.

The fact that only one vacuum, i.e. rough or fine vacuum, is ever applied to the valve set means that substantially less time is needed for the evacuation of the chamber.

A further subject of the present invention is a method for changing a tool in which the valves are also replaced together with the tool.

The disclosure made in relation to this subject of the present invention applies to the same extent to the other subjects of the present invention and vice versa.

This method according to the invention has the advantage that a valve specifically provided for the respective tool is installed together with the tool.

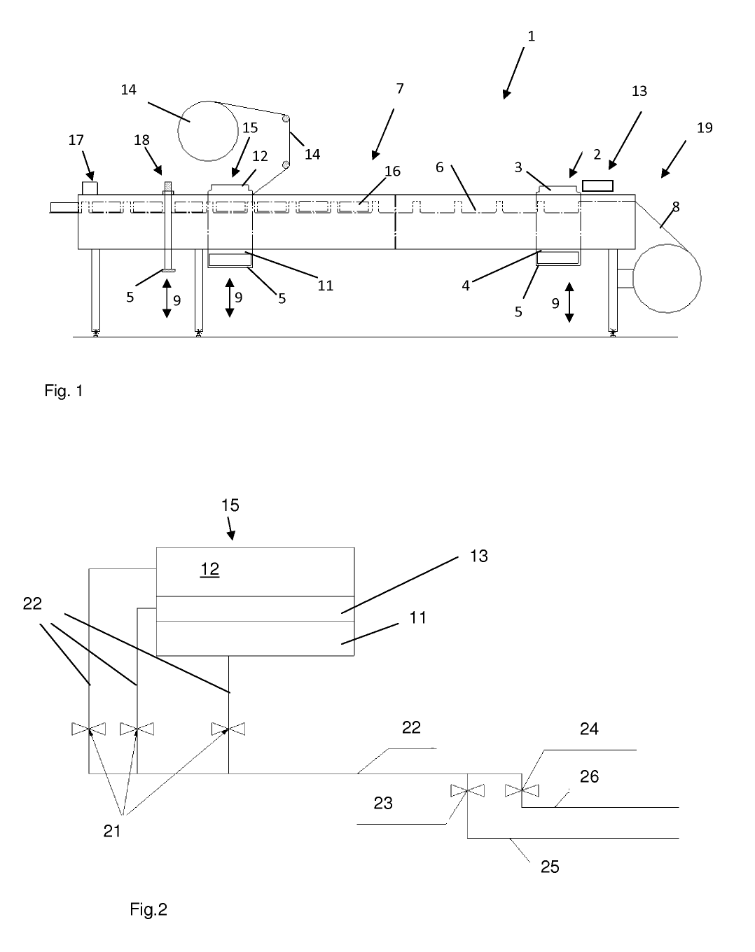

In the following text, the invention will be explained by using the FIGS. 1 to 3. These explanations are merely exemplary and do not restrict the general concept of the invention. The explanations apply equally to all the subjects of the present invention.

FIG. 1 shows the packaging machine according to the invention.

FIG. 2 shows a sealing station according to the prior art.

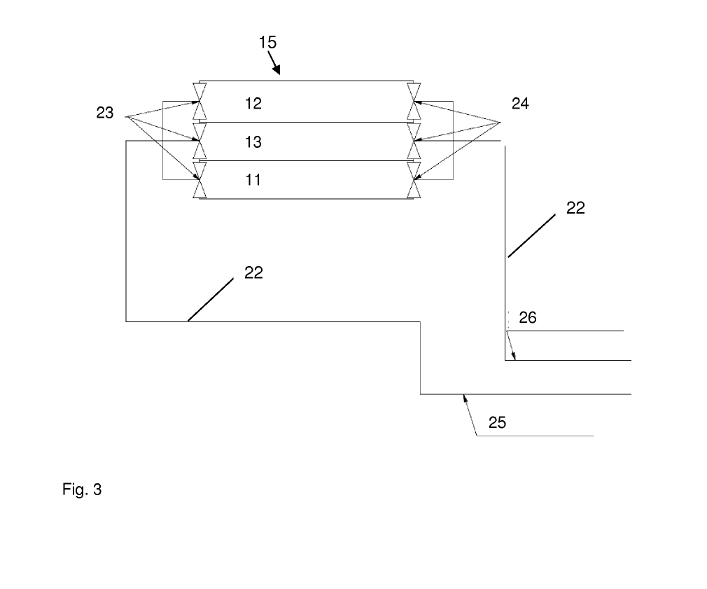

FIG. 3 shows a sealing station of the packaging machine according to the invention.

FIG. 1 shows the packaging machine 1 according to the invention, which here has a deep-drawing station 2, a filling station 7 and a sealing station 19, i.e. is an FFS packaging machine. A lower film web 8, here a plastic film web 8, is drawn off a supply roll and transported cyclically from right to left along the packaging machine according to the invention. During a cycle, the lower film web 8 is transported onward by one format length. For this purpose, the packaging machine has two transport means (not illustrated), in the present case respectively two endless chains which are arranged on the right and left of the lower film web 8. Both at the start and at the end of the packaging machine, at least one gear wheel, around which the respective chain is deflected, is respectively provided for each chain. At least one of these gear wheels is driven. The gear wheels in the input area and/or in the output area can be connected to each other, preferably by a rigid shaft. Each transport means has a multiplicity of clamping means, which grip the lower film web 8 in a clamping manner in the input area 24 and transfer the movement of the transport means to the lower film web 8. In the output area of the packaging machine, the clamping connection between the transport means and the lower film web 8 is released again. First of all, the lower film web 8 is heated, in particular heated to its glass temperature. This is preferably carried out while the film web is at a standstill. In the following deep-drawing station 2, which has an upper tool 3 and a lower tool 4 which has the shape (female die) of the packaging depression to be produced, the packaging depressions 6 are molded into the film web 8. The lower tool 4 is arranged on a lifting table 5 which, as symbolized by the double arrow, can be displaced vertically. Before each film feed, the lower tool 4 is lowered and then raised again. Preferably, the molding of the lower web per packaging depression is particularly preferably at least assisted by a plunger, which is respectively provided on the upper tool 3 and is lowered by a drive from a raised parking position into a molding position and raised again before the onward transport of the film web 8. In the further course of the packaging machine, the packaging depressions are then filled in the filling station 7 with the sliced material 16 to be packaged. In the following sealing station 15, which likewise comprises an upper tool with an upper chamber 12 and a vertically displaceable lower tool with a lower chamber 11, an upper film 14 is fixed integrally to the lower film web 8, preferably by means of sealing. For this purpose, the sealing station generally ahs a heated sealing frame. Also in the sealing station, the upper tool and/or the lower tool are lowered and raised, respectively, before and after each film transport. The upper film 14 can also be guided in transport means or transported by transport chains, these transport means then extending only from the sealing station and possibly downstream. Furthermore, the upper film can also be deep-drawn and be heated before the deep drawing. Otherwise, the explanations which have been made in relation to the transport means of the lower film apply. In the further course of the packaging machine, the finished packages are separated, which in the present case is carried out by using the transverse cutter 18 and the longitudinal cutter 17. The transverse cutter 18 in the present case can likewise be raised and lowered by using a lifting device 9.

For the case in which the packaging machine according to the invention is only an FS packaging machine, i.e., for example, is a traysealer, it has only one filling and one sealing station. In this case, the action of cutting out the finished package from the upper film is preferably carried out in the sealing station as a contour cut.

FIG. 2 shows a sealing station 15 according to the prior art. This has an upper tool 12, a lower tool 11 and in the present case a product chamber 13. By using the upper and lower tool, an upper film is sealed to a packaging depression under the influence of temperature and pressure. Before the sealing, a gas exchange is carried out in the packaging depression. For this purpose, the existing air volume in the packaging depression must first be reduced by means of vacuum. In the present case, a rough vacuum is applied first and then a fine vacuum. Accordingly, the sealing station has a rough vacuum source 26, for example a vacuum vessel or a vacuum pump, and a fine vacuum source 25, for example a vacuum vessel or a vacuum pump. Downstream of the sources 25, 26 there are arranged a fine vacuum valve 23 and a rough vacuum valve 24, which are in turn connected downstream to a conduit 22 which connects the valves 23, 24 to the respective tool 11-13. For the drawing of the rough vacuum, the valves 24 and 21 are opened. The valve 23 is closed. For the changeover from rough to fine vacuum, the valve 21 is closed again and the valve 23 is opened. The embodiment according to the prior art has the disadvantage that the entire volume of the conduit 22 firstly has to be sucked empty before the pressure in the tools 11-13 can be reduced to the pressure of the fine vacuum.

FIG. 3 shows the solution according to the invention. At least one tool, here all the tools 11-13, has/have two valves 23, 24, which are preferably integrated into the respective tool. The valve seat of the valves 23, 24 is preferably machined into the respective tool. There is no conduit between the valves 23, 24 and the tool 11-13. The valves 23 are connected directly to the fine vacuum source via the conduit 22. The valves 24 are connected directly to the rough vacuum source via a conduit 22. In order to establish the rough vacuum in the tools 11-13, the valves 24 are opened. When changing over from rough to fine vacuum, the valves 24 are closed and the valves 23 are opened. The fact that the valves are part of the respective tool means that the respective vacuum is present in the respective tool 11-13 immediately after the opening of the valves. The conduit 22 does not have to be sucked empty first and can be designed so as to be optimized for flow. In the event of a tool change, the valves 23, 24 are replaced with the respective tool.

### LIST OF DESIGNATIONS

1 Packaging machine

2 Molding station, deep-drawing station

3 Upper tool of the deep-drawing station

4 Lower tool of the deep-drawing station

5 Lifting table, carrier of a tool of the sealing, deep-drawing station and/or of the cutting device

6 Packaging depression

7 Filling station

8 Film web, lower film web

9 Lifting device

10 Drive

11 Lower chamber of the sealing station

12 Upper chamber of the sealing station

13 Product chamber

14 Upper film web, cover film

15 Sealing station

16 Material to be packaged

17 Longitudinal cutter

16 Transverse cutter

19 Input area

20 Deep-drawing plunger

21 Vacuum valve

22 Conduit

23 Fine vacuum valve

24 Rough vacuum valve

25 Fine vacuum source

26 Rough vacuum source

1. A packaging machine having:
i. a filling station, in which packaging depressions are filled with a material to be packaged,
ii. a sealing station having an upper tool with an upper chamber and a lower tool with a lower chamber which seal an upper film web to the packaging depressions,
wherein the seating station has two valves,
wherein one valve connects the lower tool reversibly to a rough and/or a fine vacuum source and one valve connects the upper tool reversibly to the rough and/or fine vacuum source,
characterized in that each of the valves are arranged on the upper tool and on the lower tool.

2. The packaging machine as claimed in claim 1, characterized in that each of the valves have a valve seat and a movable element which, interacts in a sealing manner with the valve seat, and in that the valve seat, is part of the lower tool or the upper tool and/or the upper chamber and/or the lower chamber and/or a product chamber.

3. The packaging machine as claimed in claim 2, characterized in that the valve seat is provided in one piece with the lower tool and/or the upper tool and/or with the upper chamber and/or the lower chamber and/or with the product chamber.

4. The packaging machine as claimed in claim 3, characterized in that in a region of the lower tool and/or the upper tool and/or in a region of the upper chamber and/or the lower chamber and/or the product chamber, in each case two valves are provided, wherein one valve has only fine vacuum applied thereto and another valve has only rough vacuum applied thereto.

5. The packaging machine as claimed in claim 4, characterized in that the valve that has only the rough vacuum applied thereto is provided as a non-return flap.

6. A sealing tool of a packaging machine, the sealing tool has two valves,
characterized in that each of the valves has a valve seat and a movable element which interacts in a sealing manner with the valve seat, and in that each valve seat is part of a lower tool or an upper tool and/or an upper chamber and/or a lower chamber and/or a product chamber.

7. The sealing tool as claimed in claim 6, characterized in that the valve seat is provided in one piece with the lower tool and/or the upper tool.

8. A method for evacuating a chamber, characterized in that firstly a rough vacuum is applied to a first valve set, which comprises at least two valves, and then a fine vacuum is applied to another valve set), which comprises at least two other valves.

9. The packing machine a claimed in claim 1, wherein, the packing machine is free of any conduits extending between each of the valves and the upper tool and the lower tool.

10. The packing machine as claimed in claim 1, wherein the packing machine has a deep-drawing station located upstream of both the filling station and the sealing station, the deep-drawing station comprises one or more deep-drawing upper tools and one or more deep-drawing lower tools,
wherein the one or more deep-drawing lower tools have a shape generally corresponding to the packaging depressions formed in a lower web, and
wherein the one or more deep-drawing upper tools and the one or more deep-drawing lower tools are raised and lowered to form the packaging depressions in the lower film web.

11. The packaging machine as claimed in claim 2, wherein the product chamber is defined between the packaging depressions and the upper film web.

12. The packaging machine as claimed in claim 4, wherein the rough vacuum has a pressure range between about 50 mbar and 70 mbar, and the fine vacuum has a pressure range between about 5 mbar and 10 mbar.

13. The packaging machine as claimed in claim 1, wherein during a tool change, the valves are replaced jointly with the lower tool and the upper tool.

14. The packaging machine as claimed in claim 3, wherein the valve seat of each of the valves is machined into the lower tool, the upper tool, the lower chamber, the upper chamber, and/or the product chamber.

15. The sealing tool as claimed in claim 6 wherein the packaging machine is tree of any conduits extending between the valve seat of each of the two valves and the lower tool, the lower chamber, the upper tool, the upper chamber, and/or the product chamber.

16. The sealing tool of claim 6, wherein the packing machine comprises:
i. a deep-drawing station comprising one or more upper deep-drawing tools and one or more lower deep-drawing tools, the one or more upper deep-drawing tools and the one or more lower deep-drawing tools are raised and lowered, to form one or more packaging depressions in a lower film web;
ii. a filling station located downstream of the deep-drawing station in which the one or more packaging depressions are filled with a material to be packaged, and
iii. a sealing station located downstream of the filling station, the sealing station comprising the sealing tool to seal an upper film web to the one or more packaging depressions,
wherein the packing machine comprises additional valves of the two valves such that the lower tool includes two valves, the upper tool includes two valves, and the product chamber includes two valves, and
wherein a rough vacuum is applied to one of the two valves in the lower tool, the upper tool, and the product chamber, and a fine vacuum is applied to the other of the two valves in the lower tool, the upper tool, and the product chamber.

17. The packaging machine as claimed 16, wherein the packing machine is free of any conduits extending between the lower tool and the corresponding two valves, the upper tool and the corresponding two valves, and the product chamber and the corresponding two valves.

18. The method of claim 8, wherein at least one valve of the first valve set is machined into a lower tool and at least one valve of the first valve set is machined into an upper tool, and
wherein at least valve of the second valve set is machined into the lower tool and at least valve of the second valve set is machined into the upper tool.

19. The method of claim 18, wherein the method includes a step of changing the lower tool, which includes jointly replacing the corresponding valves that are machined into the lower tool, and changing the upper tool, which includes jointly replacing the corresponding valves that are machined into the upper tool, and
wherein the lower tool and the upper tool are part of a packaging machine.

20. The method of claim 19, wherein the packaging machine is free of any conduits extending between the lower tool and the valves that are machined into the lower tool and the upper tool and the valves that are machined into the upper tool.
